(19) United States
(12) Patent Application Publication
(10) Pub. No.: US 2002/0153692 A1
(43) Pub. Date: Oct. 24, 2002

(54) One-piece curved yoke for motorcycles

(76) Inventors: Roger David Scott Goldammer, Kelowna (CA); Scott Ronald Johnson, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/101,941

(22) Filed: Mar. 21, 2002

Related U.S. Application Data
(60) Provisional application No. 60/284,518, filed on Apr. 19, 2001.

(51) Int. Cl. B62K 21/04

(52) U.S. Cl. 280/279

(57) ABSTRACT

A front fork yoke for a motorcycle where the yoke includes a parallel pair of posts rigidly maintained laterally spaced apart by a pair of parallel semi-circular arches extending laterally between the posts. The imposts of the upper arch are curved rounded-over shoulders. The front face of the yoke is smoothly rounded-over towards the rear face of the yoke. The arches are upwardly convex and support the motorcycle head tube therebetween.

### CROSS REFERENCE TO RELATED APPLICATION

This application claims priority from U.S. Provisional Patent Application No. 60/284,518 filed Apr. 19, 2001 entitled One-Piece Conventional-Fork Curved Yoke For Motorcycles.

### FIELD OF THE INVENTION

This invention relates to the field of devices for securing motorcycle front forks to the head tube of the motorcycle frame, and in particular, to an improved yoke for the mounting of front forks to the head tube.

### BACKGROUND OF THE INVENTION

As seen in FIGS. 1 and 2, it is known in the prior art to use angularly shaped sharp or hard-edged yokes for pivotally mounting motorcycle front forks to the head tube of the motorcycle frame. For use on motorcycles such as Harley Davidson™ motorcycles, such components may be purchased from vendors such as Perse Performance™ of Englewood, Colo., for example components from that vendor referred to as Triple Trees™. Conventionally yokes such as the Triple Tree kits marketed by Perse Performance™ are manufactured as a kit of separate components that must be assembled to form the yoke. This introduces the potential for a loss of rigidity of the yoke, such a loss of rigidity being undesirable in that the front wheel of the motorcycle is cantilevered from the yoke at the end of relatively long forks and thus subject to considerable force, bending moment and vibration.

There is a significant aftermarket in customizing motorcycles such as Harley Davidson™ motorcycles. One such example is the subject of FIG. 2, being a customized motorcycle used for display at motorcycle shows and the like. As may be seen, the customizing of the motorcycle results in a significantly rounded, flowing design where the conventional teardrop shape of the fuel tank is modified so that the fuel tank flows conformally into the seat pad saddle which itself then flows curvaceously into the swell of the rear fender. This lends the motorcycle a low elegantly curved profile. The curved low side-on profile is complemented by the use of aft-swept arcuately curved handlebars sweeping back from where they are mounted to the yoke immediately adjacent the head tube of the frame to which the motor and lower decorative fairings or cowlings are mounted. The yoke conventionally supports the forward extending forks, the front wheel and front fender mounted cantilevered on the distal end of the forks. Conventionally, the headlight is mounted to, so as to extend forwardly from between the uprights of the yoke.

The use of a prior art yoke on such a customized motorcycle, or for that matter other customized motorcycles which have rearwardly flowing curved lines in side-on profile, rather harshly interrupts the flowing lines of the profile due to the conventional hard-edged mounting of the upright struts in their laterally spaced apart array between the vertically spaced apart pair of generally triangular mounting plates.

Thus in the present invention it is an object to provide a yoke which is, contrary to the motorcycle prior art of which applicant is aware, all one piece and which smoothly and aerodynamically curves rearwardly so as to complement the rearward flowing lines of the adjacent teardrop-shaped fuel tank on the motorcycle when the yoke is mounted to the head tube.

### SUMMARY OF THE INVENTION

In summary the present invention is a unitary, one-piece front fork yoke for a motorcycle. The yoke may include upper and lower arches extending between a parallel pair of posts. Each post has an upper end and an opposite lower end. The upper arch extends from and between each upper end of the posts. Each upper end forms an impost at opposite ends of the upper arch.

The lower arch parallels the upper arch and is mounted to, so as to extend between, the lower ends of the pair of posts or adjacent the lower ends of the posts. The upper and lower arches each have a vertice lying on or adjacent an axis of rotation of the yoke when the yoke is mounted to a motorcycle frame so that a head tube of the frame is coaxial with the axis of rotation and is mountable snugly between the vertices of the upper and lower arches. The upper and lower arches each form a corresponding concavity under each arch which opens downwardly towards the lower ends of the posts.

The imposts form a pair of rounded-over shoulders between the upper arch and the posts. The shoulders are rounded in a plane containing the pair of posts so as to smoothly blend outer surfaces of the upper ends of the posts into outer surfaces of opposite ends of the upper arch, and are rounded-over between the front and rear of the yoke.

The pair of posts and the arches collectively have a front face, for facing forwardly from the motorcycle when the yoke is mounted to the motorcycle frame, and an opposite rear face. The arches have corresponding rear surfaces. Protrusions on the rear surfaces of the arches are curved so as to smoothly protrude rearwardly adjacent the vertices of the arches. The protrusions are adapted for vertically aligned mounting of the head tube therebetween. The front face is smoothly rounded over toward the rear face around forwardly exposed edges of the posts and the arches. The shoulders are rounded so as to smoothly blend from the front face at the upper ends of the posts, upwardly into the opposite ends of the upper arch and rearwardly so as to round smoothly into the rear face. The yoke is adapted so that the front face rakes, and is curved upwardly, aft when the yoke is mounted on the motorcycle frame, whereby a side profile of the yoke smoothly and aerodynamically blends into aft flowing curved lines of the motorcycle.

In one embodiment the pair of posts may be a pair of cylinders and the arches may each be generally semi-circular, that is, semi-circular or a lesser segment of a circle. The shoulders may be cupped so that each is shaped in the form of a cup-segment, that is, smoothly rounded as might be a well muscled human shoulder. Thus the arches and the shoulders may each have an upper surface which is rounded from the front face to the rear face of the yoke symmetrically about the above-defined plane, in which case the plane bisects the pair of posts so that longitudinal axes of symmetry of each post lie in the plane.

### BRIEF DESCRIPTION OF THE DRAWINGS

FIG. 1 is, in perspective view, a prior art motorcycle yoke.

FIG. 2 is, in perspective view, a customized motorcycle incorporating the prior art yoke of FIG. 1.

FIG. 3 is, in perspective view, the yoke of the present invention mounted to a motorcycle frame.

FIG. 4 is, in perspective view, the yoke of FIG. 3 mounted to front forks.

FIG. 5 is, in perspective view, the customized motorcycle of FIG. 2 employing the improved yoke of the present invention.

FIG. 6 is, in enlarged view, the yoke of FIG. 3.

FIG. 7 is, in rear perspective view, the yoke of FIG. 5.

FIG. 8 is, in front perspective partially exploded view, the yoke of FIG. 7.

FIG. 9 is, in exploded partially cut-away view, the head tube adjusting bracket of the yoke of FIG. 8.

### DETAILED DESCRIPTION OF EMBODIMENTS OF THE INVENTION

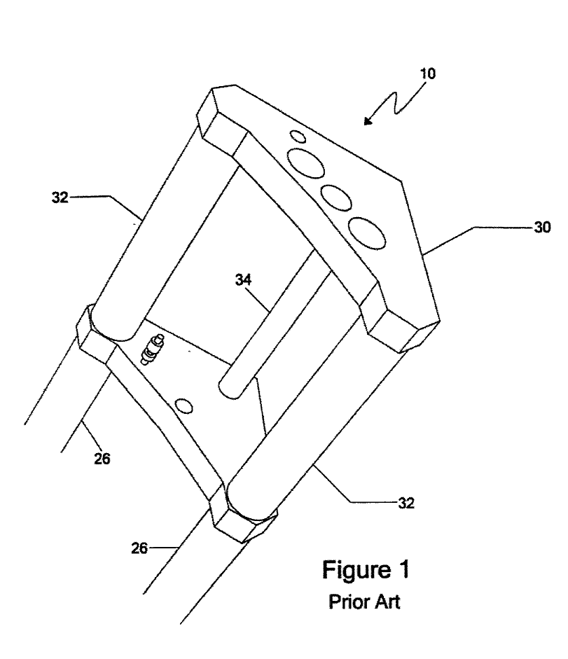

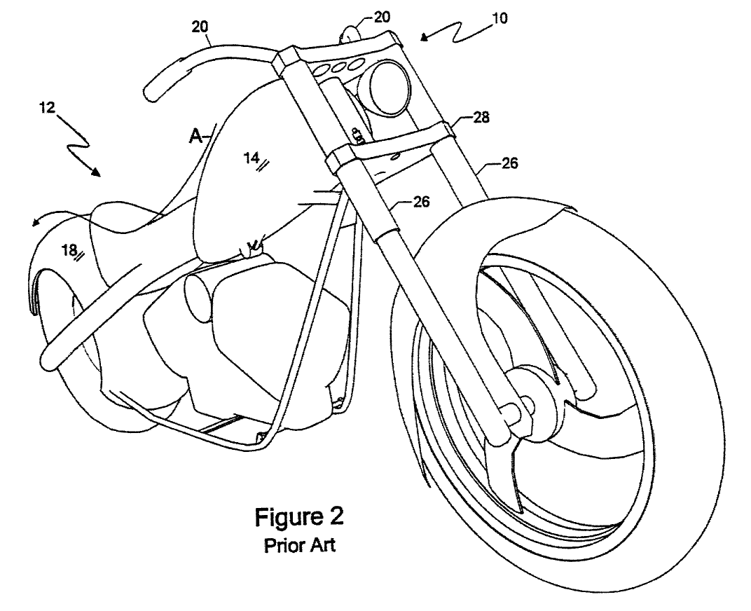

A prior art yoke 10 is illustrated in FIGS. 1 and 2, in FIG. 2 shown mounted on a customized motorcycle 12 such as a customized Harley Davidson™ motorcycle. In the illustrated example of FIG. 2, which is only intended to be by way of example and not intended to be limiting, the fuel tank 14 flows curvaceously aft, as indicated in FIG. 2 by direction arrow A, so as to conformally blend into saddle 16 and then swell arcuately over curved rear fender 18. The flowing profile of fuel tank 14, saddle 16 and fender 18 is complemented by the rearwardly arcuately swept shape of handlebars 20 and by the shape of front fender 22 which is conformally curved to front wheel 24.

Front wheel 24 and fender 22 are mounted to the forward or distal ends of conventional forks 26, forks 26 being rigidly mounted to, so as to extend cantilevered from, the base plate 28 of prior art yoke 10.

As better seen in FIG. 1, prior art yoke 10 consists of base plate 28 mounted in parallel spaced apart relation to top plate 30 by three parallel spaced apart posts including a pair of laterally spaced posts 32 and a central post 34. Central post 34 pivotally mounts into the correspondingly-sized head tube of the motorcycle frame so as to allow steering by pivoting of front wheel 24 about the longitudinal axis of the head tube. The parts are bolted together.

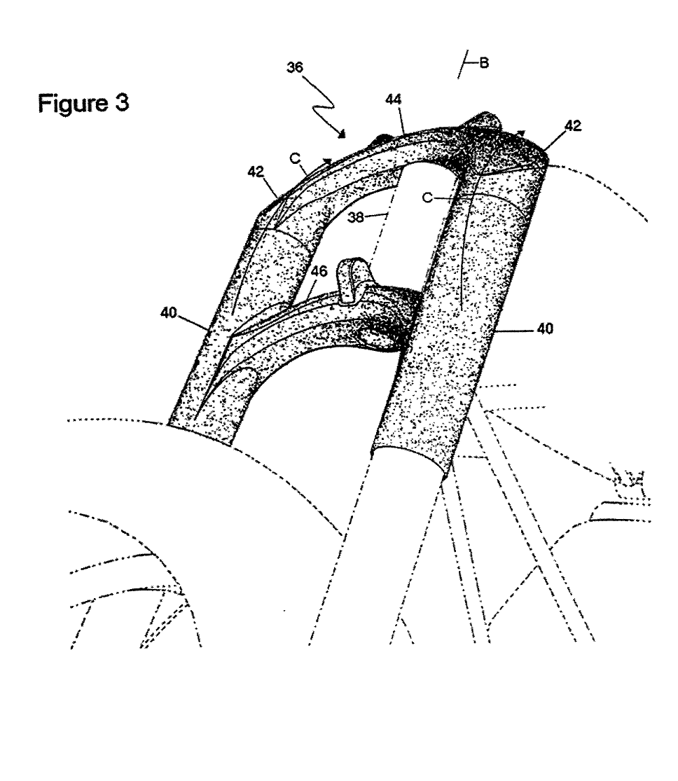

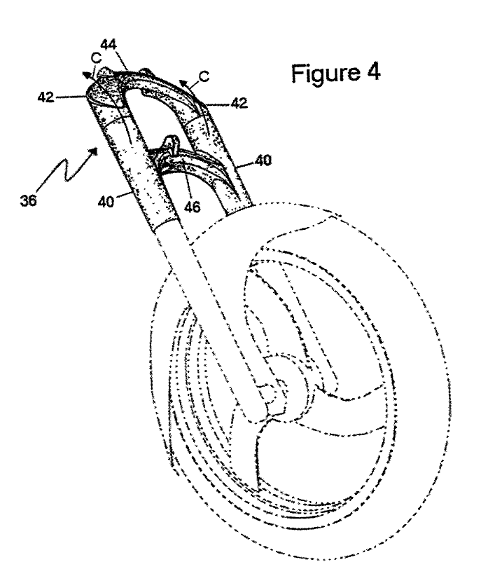

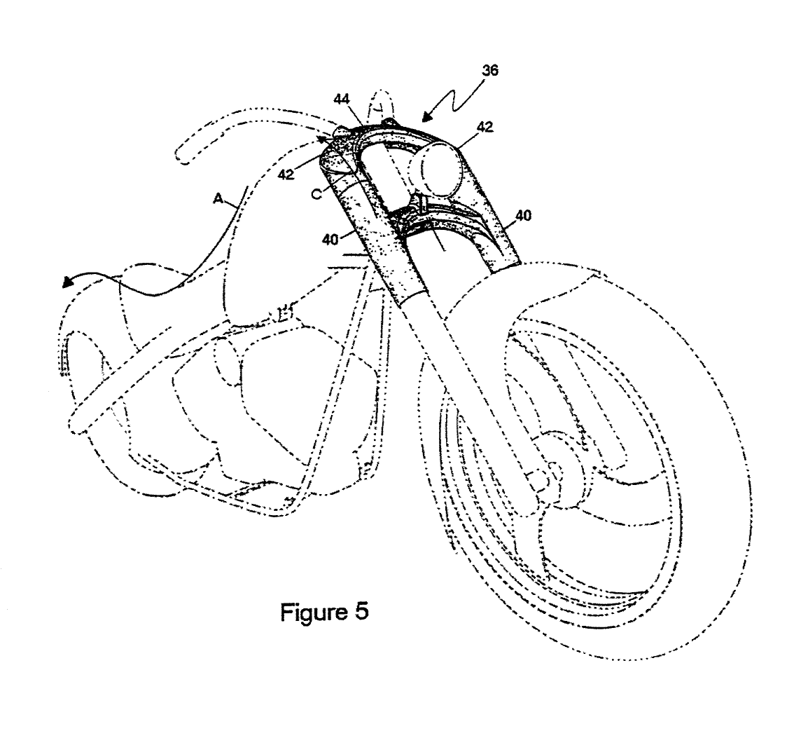

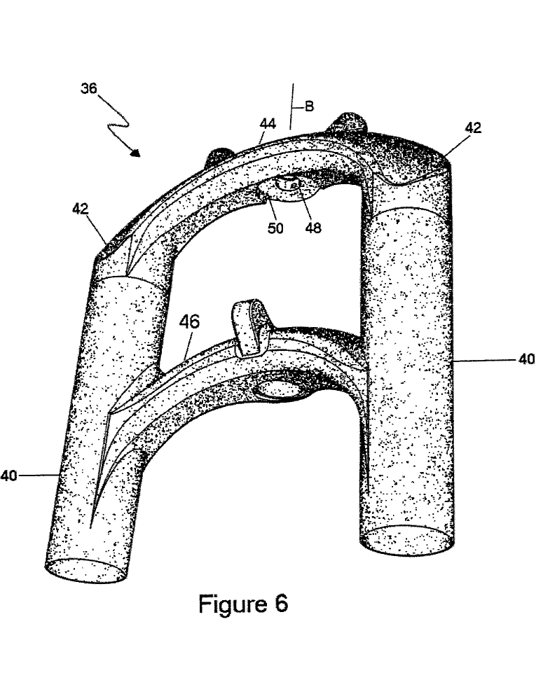

As seen in FIGS. 3-6, the yoke 36 of the present invention is smoothly and aerodynamically contoured so that, once mounted to head tube 38 so as to be angled or raked aft, for example in the conventional 35 degree to horizontal orientation of forks 26, the rounded pair of columnar uprights 40 smoothly blend at shoulders 42 upwardly and rearwardly into arch 44 which itself curves upwardly and rearwardly from shoulders 42 so as to medially intersect the axis of rotation B of head tube 38. Yoke 36 is a single unitary piece, for example milled, cast or forged. This reduces vibration and increases rigidity which provides advantages over the prior art. For example the yoke will support longer chopper-style forks with improved rigidity and may be lighter than conventional yokes because of the use of less fasteners. It may also be less expensive to manufacture. The surfaces of shoulders 42 and arch 44 are rounded-over from front to back so that a tangent to the curvature of the surfaces becomes approximately parallel to the curvature of fuel tank 14 along line A. A correspondingly formed arch 46 extends in generally parallel array with arch 44 between the lower ends of uprights 40 so as to medially intersect axis of rotation B below head tube 38.

Thus, once yoke 36 is mounted onto head tube 38, the aft-raked flowing lines of yoke 36 such as illustrated by way of example by profile lines C, complement the flowing lines exemplified by profile line A in rearwardly flowing symmetry as would be expected if the design resulted from wind tunnel testing for aerodynamic efficiency. The flowing lines exemplified by lines C as they flow upwardly and rearwardly over yoke 36 also complement the aft-raked curvature of handlebars 20 and the smoothly rearwardly flowing profile of fuel tank 14, saddle 16 and rear fender 18, and appear a natural adjunct of the curvature of front wheel 24 and fender 22.

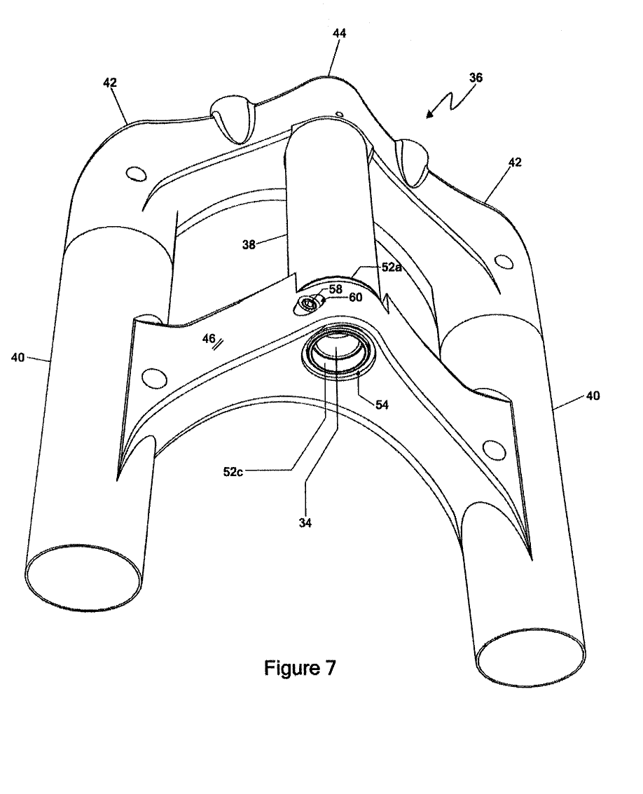

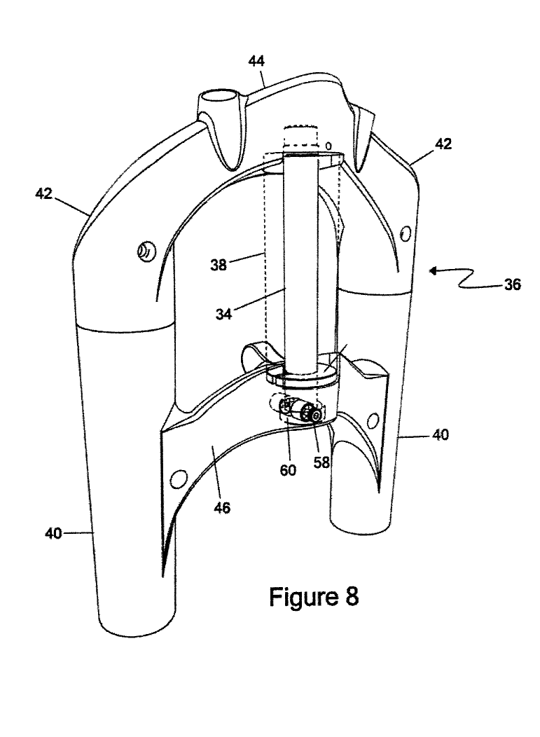

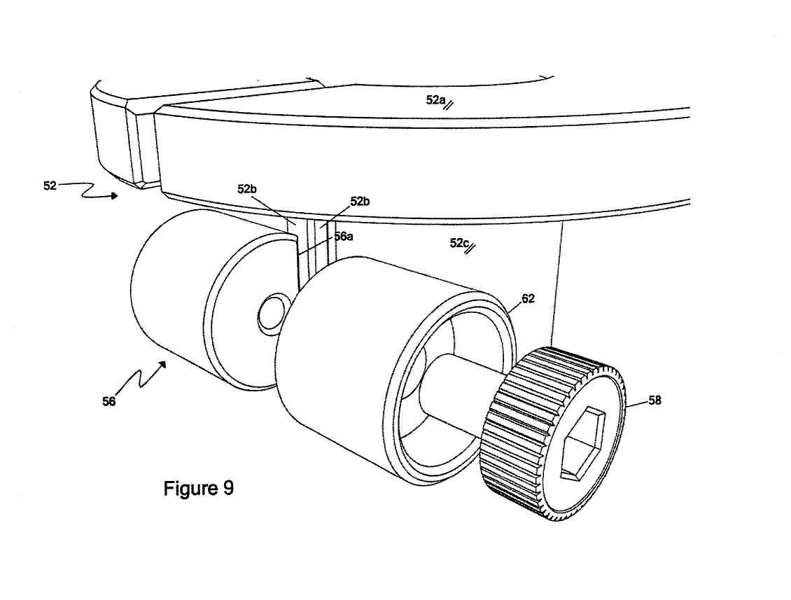

As better seen in FIGS. 7-9, head tube 38 is mounted between arches 44 and 46 rotatably onto a removable central post 34. The uppermost end of central post 34 mounts into a correspondingly sized bore 48 on the underside of arch 44, bore 48 being coaxial with axis of rotation B. The uppermost end of head tube 38 may rotatably mount within seat 50 on the underside of arch 44. Head tube 38 is held seated within seat 50 by means of adjustable collar 52 mounted snugged upwardly against the base of head tube 38 so as to snug upper collar flange 52a upwardly against the base of the head tube.

The lower or base end of central post 34 is journalled along axis of rotation B through collar 52. Arch 46 has a correspondingly sized bore 54 which extends through the arch for receiving collar 52 slidably mounted therein. With collar 52 slidably mounted within bore 54, and with flange 52a snugged upwardly against the base of head tube 38, a cammed nut 56 is threadably mounted to bolt 58 through a further bore 60 bored through arch 46 perpendicularly to bore 54. Cam surface 56a on cammed nut 56 is aligned flush against planar lands 52b on lower collar portion 52c of collar 52 so as to both clamp collar 52 onto the lower end of central post 34 and to inhibit rotation of central post 34 relative to yoke 36. Once the head of bolt 58 is tightened into cup washer 62 against cammed nut 56, movement of collar 52 along axis B is inhibited.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A front fork yoke for a motorcycle comprising:
a parallel pair of posts, each post of said pair of posts having an upper end and an opposite lower end, an upper arch extending from and between each said upper end of said each post, each said upper end being an impost at opposite ends of said upper arch,
a lower arch paralleling said upper arch and mounted to, so as to extend between, said pair of posts adjacent said lower ends of said pair of posts, said upper and lower arches each having a vertice lying generally on an axis of rotation of said yoke when said yoke is mounted to a motorcycle frame so that a head tube of the frame coaxial with said axis of rotation is mountable snugly between said vertices of said upper and lower arches, said upper and lower arches each forming a corresponding concavity under each said arch which opens downwardly towards said lower ends of said pair of posts,
wherein said pair of posts, said upper arch and said lower arch are one unitary rigid piece.

2. The apparatus of claim 1 wherein said imposts form a pair of shoulders between said upper arch and said pair of posts, said shoulders rounded in a plane containing said pair of posts so as to smoothly blend outer surfaces of said upper ends of said pair of posts into outer surfaces of opposite ends of said upper arch,
said pair of posts and said arches having a front face, for facing forwardly from the motorcycle when said yoke is mounted to the motorcycle frame, and an opposite rear face, said arches having corresponding rear surfaces, protrusions on said rear surfaces curved so as to smoothly protrude rearwardly adjacent said vertices of said arches, said protrusions adapted for vertically aligned mounting of the head tube therebetween,
wherein said front face is smoothly rounded over toward said rear face around forwardly exposed edges of said pair of posts and said arches and wherein said shoulders are rounded so as to smoothly blend from said front face at said upper ends of said posts, upwardly into said opposite ends of said upper arch and rearwardly so as to round smoothly into said rear face, said yoke adapted so that said front face rakes, and is curved upwardly, aft when said yoke is mounted on the motorcycle frame, whereby a side profile of said yoke smoothly and aerodynamically blends into aft flowing curved lines of the motorcycle.

3. The apparatus of claim 1 wherein said pair of posts are a pair of cylinders and said arches are each generally semi-circular.

4. The apparatus of claim 2 wherein said pair of posts are a pair of cylinders and said arches are each generally semi-circular.

5. The apparatus of claim 2 wherein said shoulders are cupped so that each is shaped in the form of a cup-segment.

6. The apparatus of claim 2 wherein said arches and said shoulders each have an upper surface which is rounded from said front face to said rear face symmetrically about said plane, wherein said plane bisects said pair of posts so that longitudinal axes of symmetry of said each post lie in said plane.
